(19) United States
(12) Patent Application Publication
(10) Pub. No.: US 2012/0211681 A1
(43) Pub. Date: Aug. 23, 2012

(54) PNEUMATIC ACTUATOR AIR FLOW CONTROL SYSTEM

(75) Inventor: James Wang, Taichung (TW)

(73) Assignee: EASYTORK AUTOMATION CORPORATION, Saint Louis, MO (US)

(21) Appl. No.: 13/029,472

(22) Filed: Feb. 17, 2011

(51) Int. Cl. F16K 31/12

(52) U.S. Cl. 251/30.01

(57) ABSTRACT

A pneumatic actuator air flow control system includes a pneumatic rotary actuator (PRA) and a solenoid air flow control valve (SAFCV). The PRA contains an air reservoir and two pistons on which a number of actuated racks are formed and engaged therewith, so the piston can drive the actuated rack and a pinion when the piston moves to achieve the goal of opening or closing the valve body. The SAFCV includes a flow control valve body (FCVB), a pilot solenoid valve (PSV) and a switch system, wherein the FCVB and the PRA can be connected to direct the pressurized air into the air reservoir, and the PSV is used to control the pressurized air in and out of the PRA to change the rotation direction of the pinion. Additionally, the switch system allows users to switch between a double-acting and fail-safe operation. When there is no pressurized air and/or electrical power and if an emergent need to open or close the valve, a manual override in the PSV can be used without further installation of a declutchable manual gear operator or external piping when there is no pressurized air and/or electrical power.

### FIELD OF THE INVENTION

The present invention provides a pneumatic actuator air flow control system, specifically this technology providing a pneumatic rotary actuator and a solenoid air flow control valve which allows easily switching between a double-acting and a fail-safe model. It also provides an emergency manual override operation without an external installation of a declutchable manual gear operator (gear box) or external piping in the event of no pressurized air and/or electrical power.

### BACKGROUND OF THE INVENTION

Currently, there are many kinds of actuator designs which use pressure or torque to force the rotation of the shaft in the actuator (in both clockwise and counterclockwise manners) to drive the rotary valve to open and close, and further control the on/off position of the valve in a pipeline. There are two types of pneumatic rotary actuators: single-acting and double-acting. The single-acting actuator is used on the valve that requires fail-return and traditional single-acting actuators typically rely on the compression or torsion of springs. The released force in the spring provides resilient force for the fail-return action (either fail-open or fail-close) and when there is supply of pressurized air, the spring tension must first be overcome to drive the shaft to open or close the valve, so the effective torque will decrease as the spring resistance increases. When there is no supply of pressurized air, the actuator can use returning force of the spring to rotate the shaft and valve to its fail-return position (either fail-open or fail-close). The operation is so called “fail-return,” and the output torque will decrease as tension in the spring diminishes. As to the double-acting actuator operation, generally the supply of pressurized air source is necessary and the supply of the pressurized air, which is in and out of the actuator, drives the shaft and valve to open or close. When there is no supply of pressurized air, the actuator cannot move, unlike the single-acting actuators which can rely on the spring tension as the fail-return force to fail-open or fail-close the valve. However, when there is supply for pressurized air, the open and close torque output will be far higher than that of the single-acting actuators. Traditionally the single-acting actuators and double-acting actuators require a solenoid air flow control valve in combination with gas and electricity, to open or close the valve. In the event there is no supply of pressurized air and/or electricity and there is an emergency need to open or close the valve, the traditional method is to install a declutchable manual gear operator (gear box) underneath the actuator to act as an emergency switch when there is no air source. But the disadvantage is the packaging occupies more spaces and the total cost is higher. In addition, from the manufacturing and distributor's perspective, they must produce and inventory the single-acting and double-acting actuators in response to the different needs from customers. If they cannot provide a single product that can perform both single-acting and double-acting functions, the total production and inventory costs will increase accordingly.

### SUMMARY OF THE INVENTION

The technical problem to be solved in the present invention: traditional single-acting actuators typically rely on the compression or torsion of springs. The released force in the spring provides resilient force for the fail-return action (either fail-open or fail-close) and when there is supply of pressurized air, the spring tension must first be overcome to drive the shaft to open or close the valve, so the effective torque will decrease as the spring resistance increases. When there is no supply of pressurized air, the actuator can use returning force of the spring to rotate the shaft and valve to its fail-return position (either fail-open or fail-close). The operation is so called “fail-return,” and the output torque will decrease as tension in the spring diminishes. As to the double-acting actuator operation, generally the supply of pressurized air source is necessary and the supply of the pressurized air, which is in and out of the actuator, drives the shaft and valve to open or close. When there is no supply of pressurized air, the actuator cannot move, unlike the single-acting actuators which can rely on the spring tension as the fail-return force to fail-open or fail-close the valve. However, when there is supply for pressurized air, the open and close torque output will be far higher than that of the single-acting actuators. Traditionally the single-acting actuators and double-acting actuators require a solenoid air flow control valve in combination with gas and electricity, to open or close the valve. In the event there is no supply of pressurized air and/or electricity and there is an emergency need to open or close the valve, the traditional method is to install a declutchable manual gear operator (gear box) underneath the actuator to act as an emergency switch when there is no air source. But the disadvantage is the packaging occupies more spaces and the total cost is higher. In addition, from the manufacturing and distributor's perspective, they must produce and inventory the single-acting and double-acting actuators in response to the different needs from customers. If they cannot provide a single product that can perform both single-acting and double-acting functions, the total production and inventory costs will increase accordingly.

The technical point to solve the problem mentioned above: providing a pneumatic actuator air flow control system which uses a pneumatic rotary actuator in combination with a solenoid air flow control valve, wherein the pneumatic rotary actuator contains an air reservoir and two pistons, wherein a number of actuated racks are formed on the piston and engaged therewith, so the piston can drive the actuated rack and a pinion when the piston moves to achieve the goal of opening or closing the valve body. Depending on different user circumstances, the specified solenoid air flow control valve can be quickly switched between the double-acting and fail-safe operations to control the valve. The solenoid air flow control valve primarily includes a flow control valve body, a pilot solenoid valve and a switch system to form the solenoid air flow control valve, wherein the flow control valve body and pneumatic rotary actuator can be connected in order to direct the source of the pressurized air into the air reservoir, the pilot solenoid valve is used to control the pressurized air flow pattern in and out of the pneumatic rotary actuator in order to change the rotation movement of the pinion, and the switch system allows users to switch between the double-acting and fail-safe operations. In the event there is no pressurized air and/or electrical power and there is an emergency need to open or close the valve, the manual override operation built in the pilot solenoid valve can be used, without further installation of a declutchable manual gear operator or external piping in the event of no pressurized air and/or electrical power.

Comparing with conventional techniques, the pneumatic actuator air flow control system in the present invention utilizes the solenoid air flow control valve to quickly switch between the double-acting and fail-safe operations depending on different user circumstances, which improves the functions of both single-acting and double-acting actuators, especially under different circumstances it does not need external installation of a declutchable manual gear operator or external piping for emergency manual override operation, which may lead to more costs, higher maintenance frequency and complexity. Through this invention the same actuator can be used for both fail-safe and double-acting functions. From manufacturing companies' perspective there is no need to invest heavily in multiple model lines, and on the other hand distributors do not need to invest more to buy both single-acting and double-acting actuators, so the inventory concern is reduced.

### BRIEF DESCRIPTION OF THE DRAWINGS

FIG. 1 illustrates a three-dimensional schematic view in the present invention.

FIG. 2 illustrates a partial schematic view of the pneumatic rotary actuator in the present invention.

FIG. 2A illustrates a partial sectional view of the pneumatic rotary actuator in the present invention.

FIG. 2B illustrates another partial sectional view of the pneumatic rotary actuator in the present invention.

FIG. 3 is an exploded view of the solenoid air flow control valve in the present invention.

FIG. 4 is another exploded view of the solenoid air flow control valve in the present invention.

FIG. 5 is a top view of the solenoid air flow control valve in the present invention.

FIG. 5A is a sectional view of the solenoid air flow control valve in the present invention.

FIG. 5B is another sectional view of the solenoid air flow control valve in the present invention.

FIG. 6 is a lateral view of the solenoid air flow control valve in the present invention.

FIG. 6A is another lateral view of the solenoid air flow control valve in the present invention.

FIG. 7A illustrates one embodiment of the fail-safe model under normal operation in the present invention.

FIG. 7B illustrates one embodiment of the fail-safe model regarding the pilot solenoid valve which is not actuated in the present invention.

FIG. 7C illustrates one embodiment of the fail-safe model regarding the air source which does not provide air in the present invention.

FIG. 8A provides one embodiment of the double-acting model under normal operation in the present invention.

FIG. 8B illustrates one embodiment of the double-acting model regarding the pilot solenoid valve which is not actuated in the present invention.

FIG. 8C illustrates one embodiment of the double-acting model regarding the air source which does not provide air in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications which might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

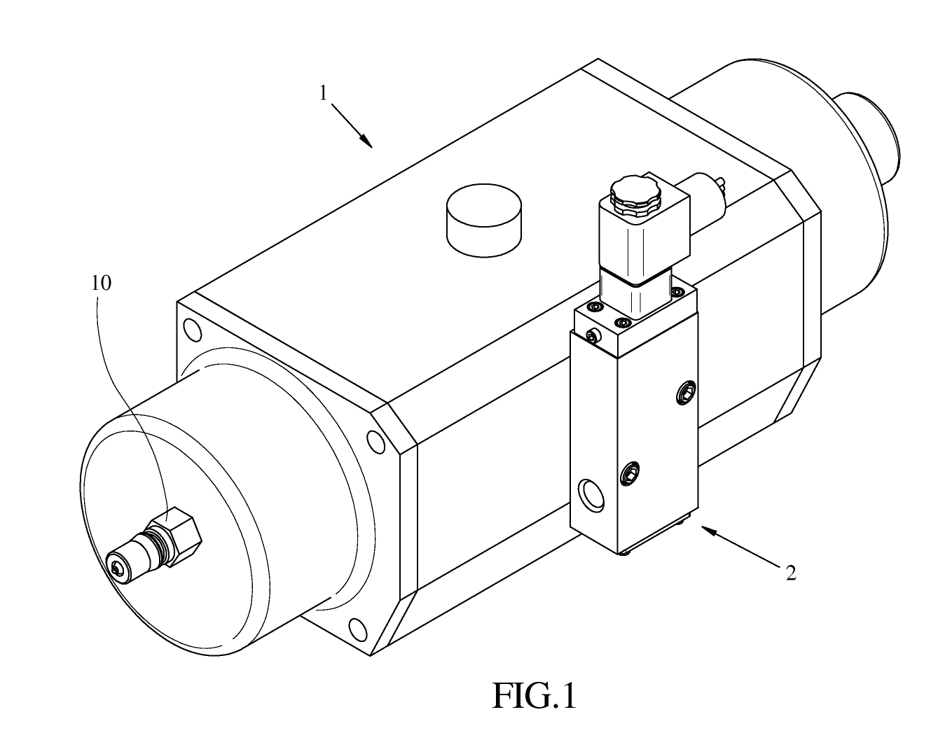

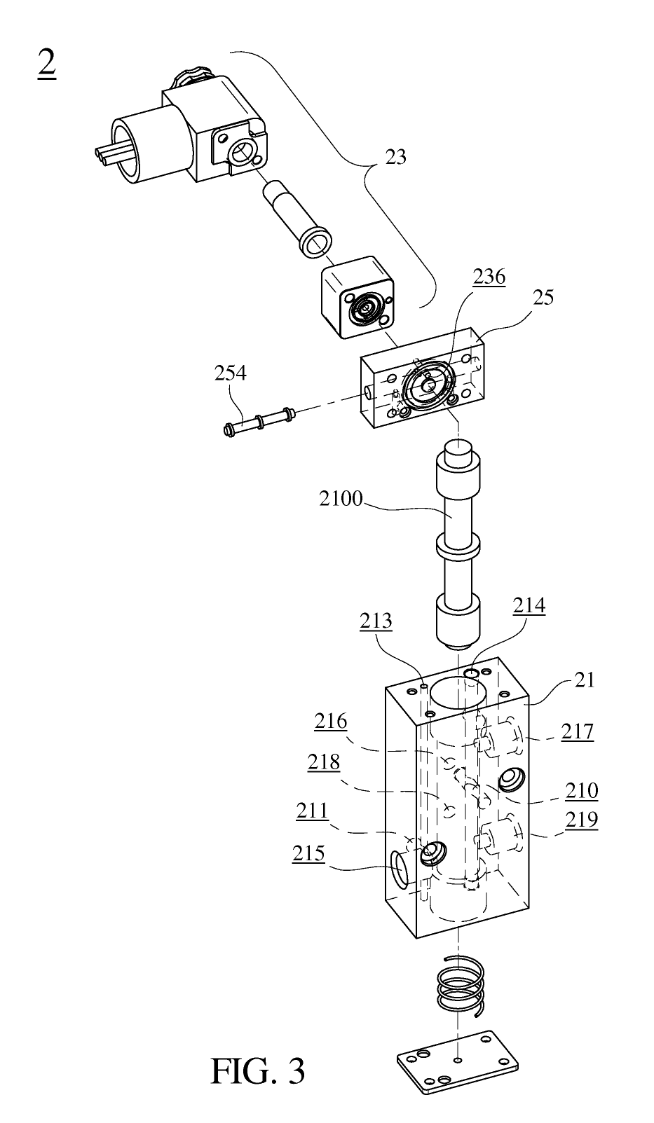

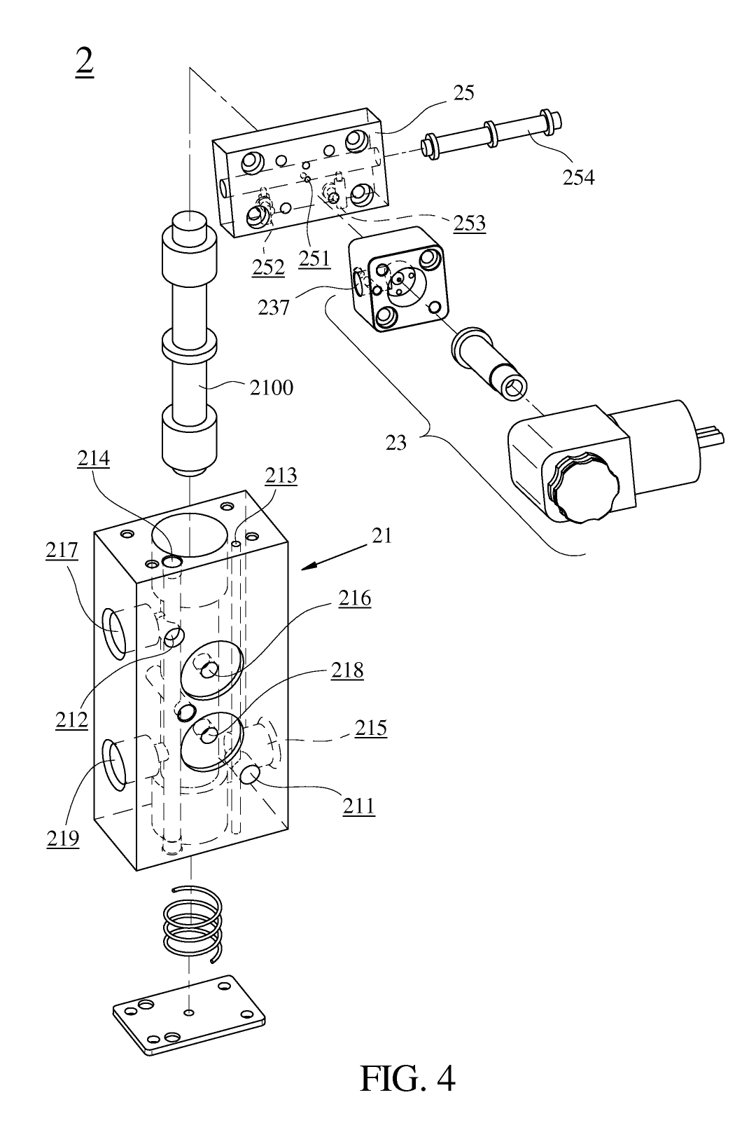

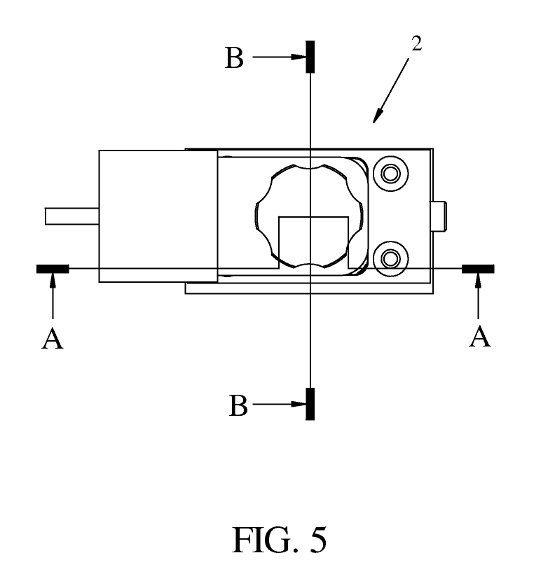

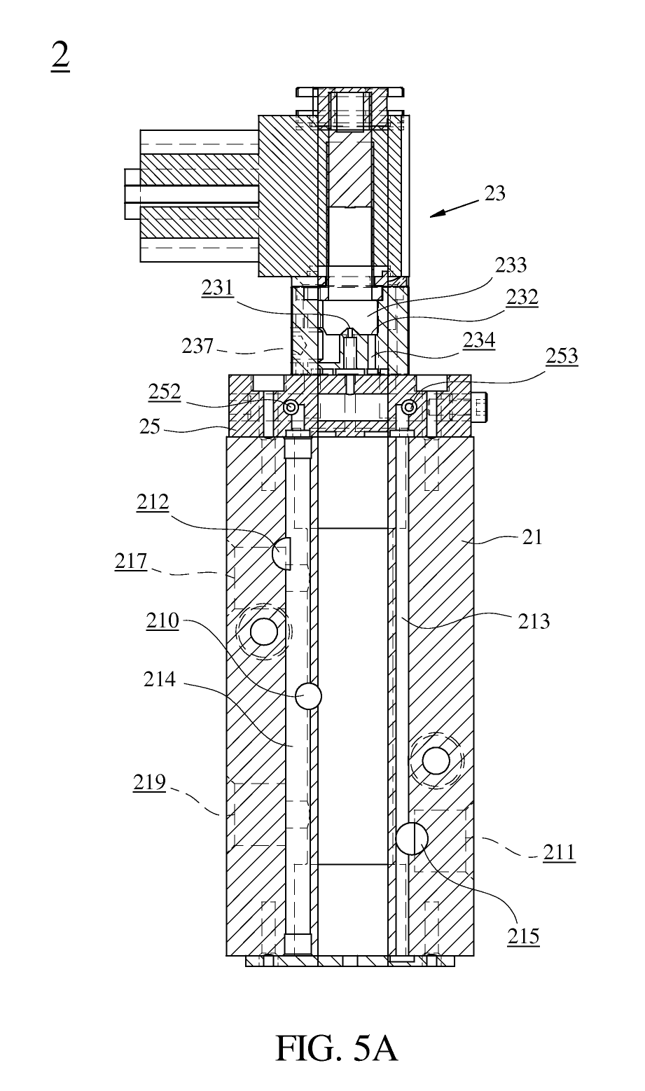

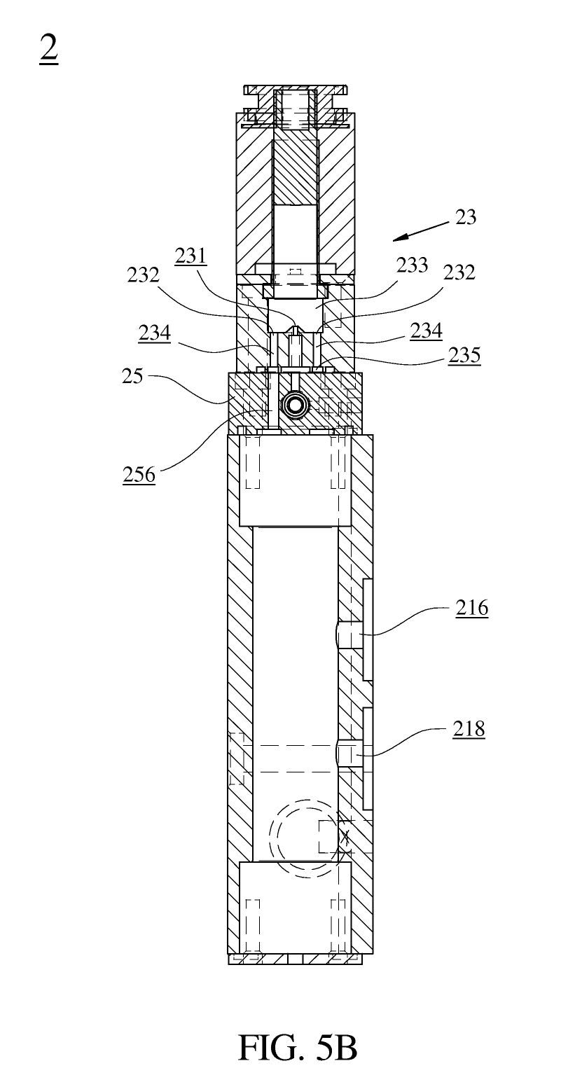

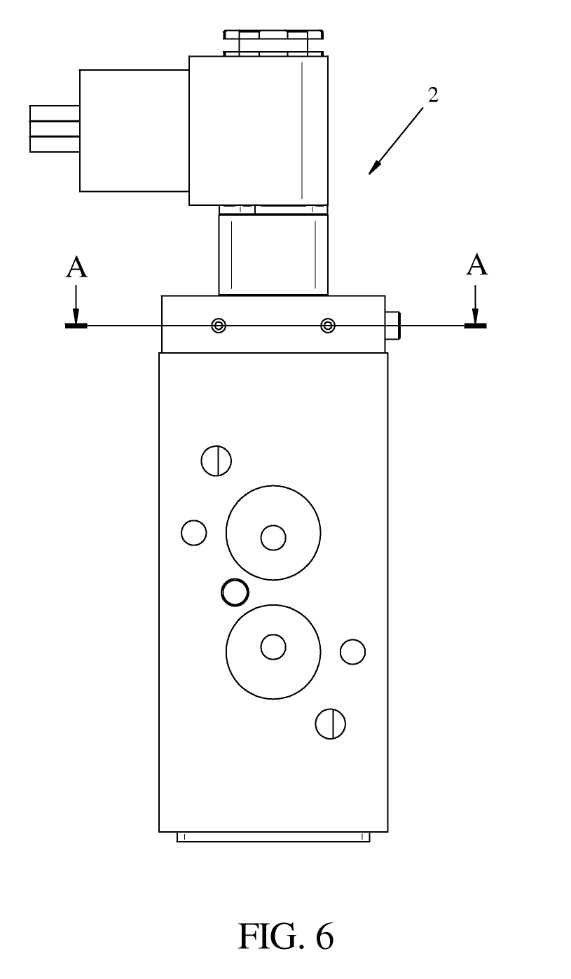

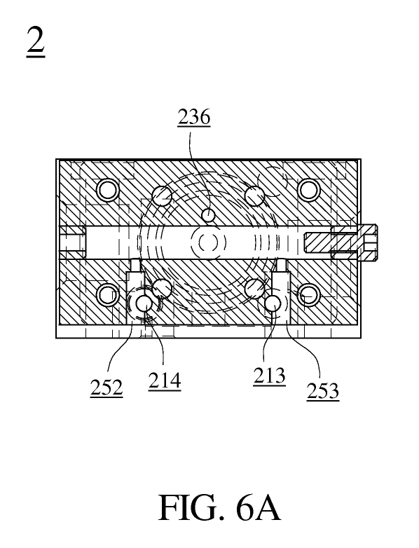

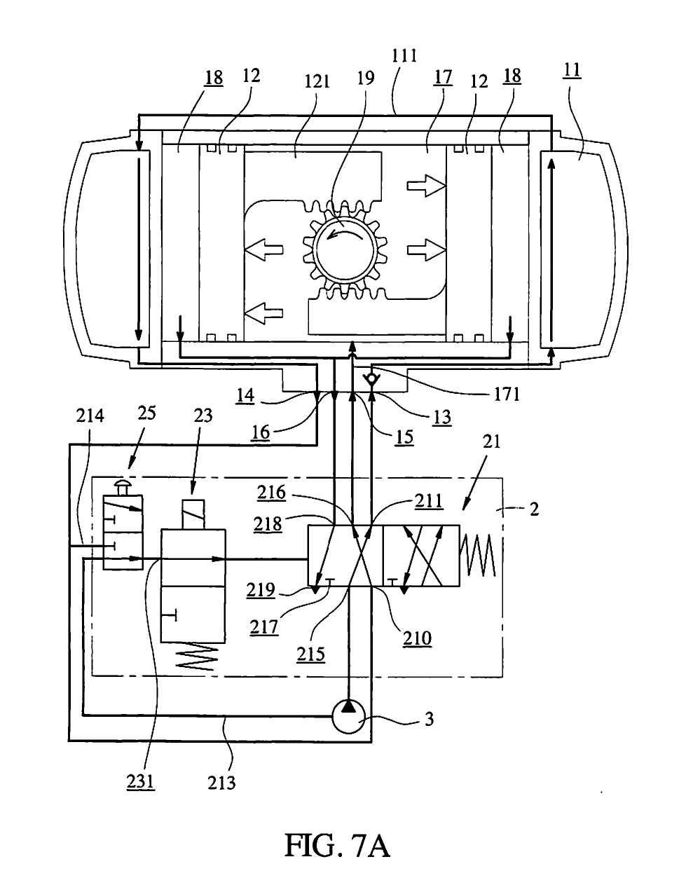

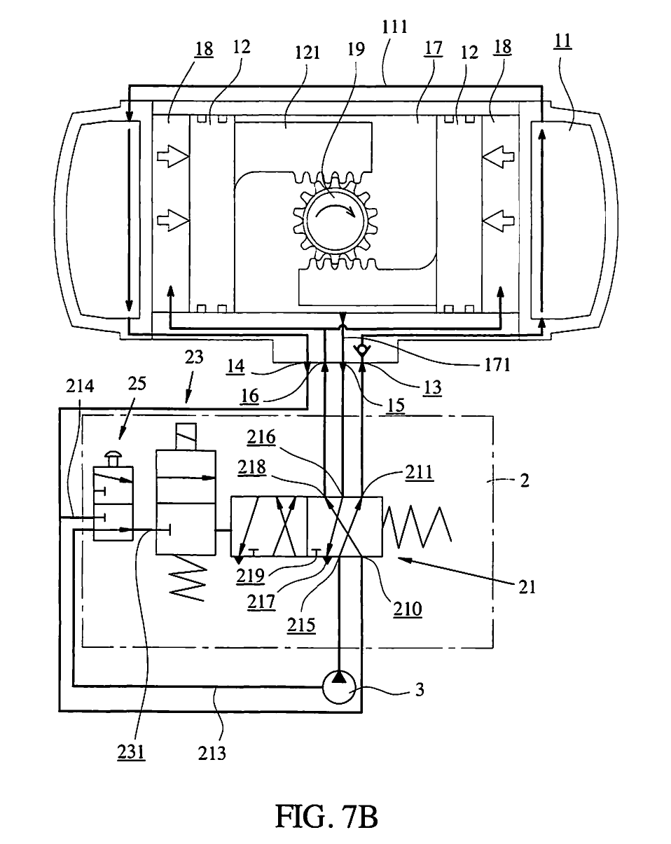

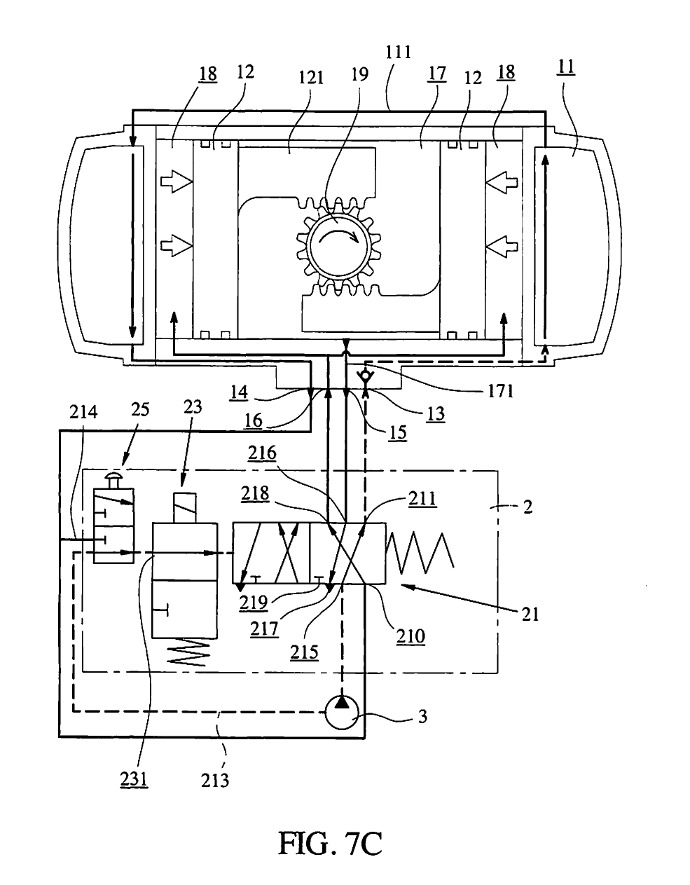

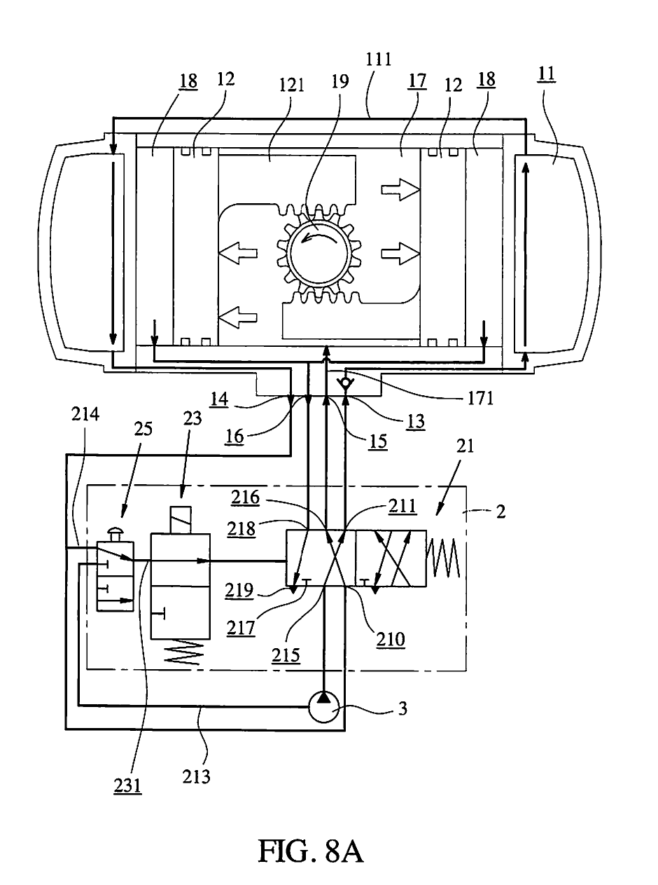

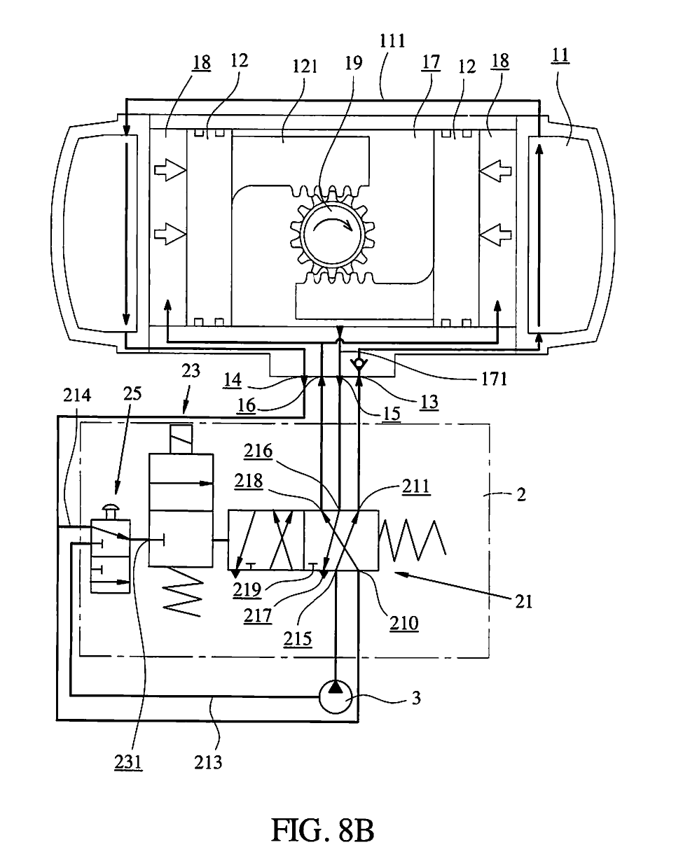

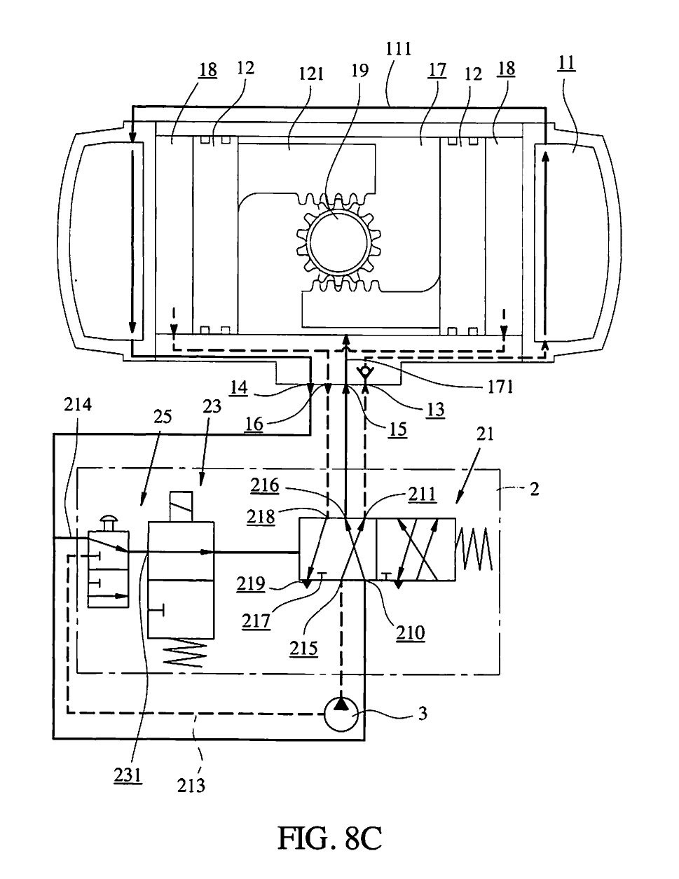

Referring to FIGS. 1 to 8C, this invention provides a pneumatic actuator air flow control system, including: a pneumatic rotary actuator (1) which includes a air reservoir (11) and two pistons (12) which divide an inner portion of the pneumatic rotary actuator (1) into a first inner space (17) next to the piston (12) and a second inner space (18) which is located at both sides of the piston (12), wherein the air reservoir (11) is located at two ends of the pneumatic rotary actuator (1) and connected with the pneumatic rotary actuator (1) with a connecting tube (111) but is not connected with the first inner space (17) and the second inner space (18), and a number of actuated racks (121) are formed on the piston (12) toward the first inner space (17) and a pinion (19) is located between the actuated racks (121) and engaged therewith, so the piston (12) can drive the actuated rack (121) and the pinion (19) when the piston moves. Also, the pneumatic rotary actuator (1) has positioning holes 1A, 1B, 1C and 1D (13, 14, 15, 16) on its lateral surface, the positioning holes 1A (13) and 1B (14) connected to the air reservoir (11) directly and the positioning hole 1A (13) having a non-return valve; the positioning hole 1C (15) connected with the first inner space (17) through a first tube (171) so the air can flow into the first inner space (17) to push the piston (12) toward the second inner space (18) to cause the pinion (19) to rotate in a counterclockwise manner to open the valve body; and the positioning hole 1D (16) connected with the second inner space (18) through a second tube (181) so that the air can flow into the second inner space (18) to push the piston (12) toward the first inner space (17) to cause the pinion (19) to rotate in a clockwise manner to close the valve body; and a solenoid air flow control valve (2) which can be quickly switched between a fail-safe mode and a double-acting mode under different circumstances; the solenoid air flow control valve (2) including a flow control valve body (21), a pilot solenoid valve (23) and a switch system (25) to be formed as one unit, wherein the flow control valve body (21) is connected with the pneumatic rotary actuator (1) and directs air flow from an air source (3) to the air reservoir (11) of the pneumatic rotary actuator (1), the flow control valve body (21) having an air reservoir air inlet port (211) and an air reservoir outlet port (212) to connect with the positioning holes 1A (13) and 1B (14) respectively, a single-acting air flow path (213) connected to the air reservoir air inlet port (211) and a double-acting air flow path (214) connected to the air reservoir outlet port (212), wherein the single-acting air flow path (213) is connected with the switch system (25) through a single-acting connector (253) and the double-acting air flow path (214) is connected with the switch system (25) through a double-acting connector (252); and the flow control valve body (21) further includes a first hole (215), a second hole (216), a third hole (217), a fourth hole (218), a fifth hole (219), an intermediate connecting port (210) and a spool (2100), wherein the first hole (215) is an inlet hole while the third hole (217) and the fifth hole (219) are outlet holes, and the intermediate connecting port (210) is located at the double-acting air flow path (214) and according to whether the spool (2100) is compressed to change its position to determine whether the air flow from the air reservoir outlet port (212) through the double-acting air flow path (214) should be connected to the second hole (216) or the fourth hole (218). If the intermediate connecting port (210) is connected with the second hole (216), the air flows through the second hole (216) and the positioning hole 1C (15) of the pneumatic rotary actuator (1) through the first tube (171) so that the air can flow into the first inner space (17) to push the piston (12) toward the second inner space (18) and causes the pinion (19) to rotate in a counterclockwise manner to open the valve body. If the intermediate connecting port (210) is connected with the fourth hole (218), the air flows through the fourth hole (218) and the positioning hole 1D (16) of the pneumatic rotary actuator (1) through the second tube (181) so that the air can flow into the second inner space (18) to push the piston (12) toward the first inner space (17) to further drive the pinion (19) to rotate in a clockwise manner to close the valve body (not shown in the figures). The pilot solenoid valve (23) of the solenoid air flow control valve (2) determines whether the air flow can pass or not and determines whether the spool (2100) of the flow control valve body (21) is compressed to change the air flow (in and out from the pneumatic rotary actuator (1)) to either the first inner space (17) or the second inner space (18) to further change the rotation direction of the pinion (19). The pilot solenoid valve (23) of the solenoid air flow control valve (2) includes a positioning hole 2A (231), at least one positioning hole 2B (232) and a plunger (233) to control whether to open or close the positioning hole 2A (231), wherein the positioning hole 2B (232) is located next to the positioning hole 2A (231), so that the air flows into the positioning hole 2A (231) is connected with the positioning hole 2B (232) to at least one combining tube (234), and a ring-shape space (235) directs the air in the combing tube (234) to a compressed tube (236) and the air flows through the switch system (25) from the compressed tube (236) into the flow control valve body (21) to compress the spool (2100). The plunger (233) can open or close the positioning hole 2A (231) through the pilot solenoid valve (23) to determine whether there is power supply or through a manual override (237) and determine whether to connect the positioning hole 2B (232) to the compressed tube (236) according to the situation (open or closed) of the positioning hole 2A (231). The switch system (25) can be manually switched to the fail-safe model and double-acting model. The switch system (25) having a switch spool (254) with axial movement and connecting with the positioning hole 2A (231) of the pilot solenoid valve (23) through a connecting path (251), so that the double-acting mode (air flowing from the double-acting air flow path (214) through the double-acting connector (252) to the switch system (25)) or the fail-safe mode (air flowing from the single-acting air flow path (213) through the single-acting connector (253) to the switch system (25)) is determined by the movement of the switch spool (254).

Under the fail-safe model and the double-acting model in the present invention, when the pilot solenoid valve (23) is not actuated due to power failure or other circumstances, or when the air source (3) does not provide air, the actuation status in the present invention is different and the actuation status is illustrated as following:

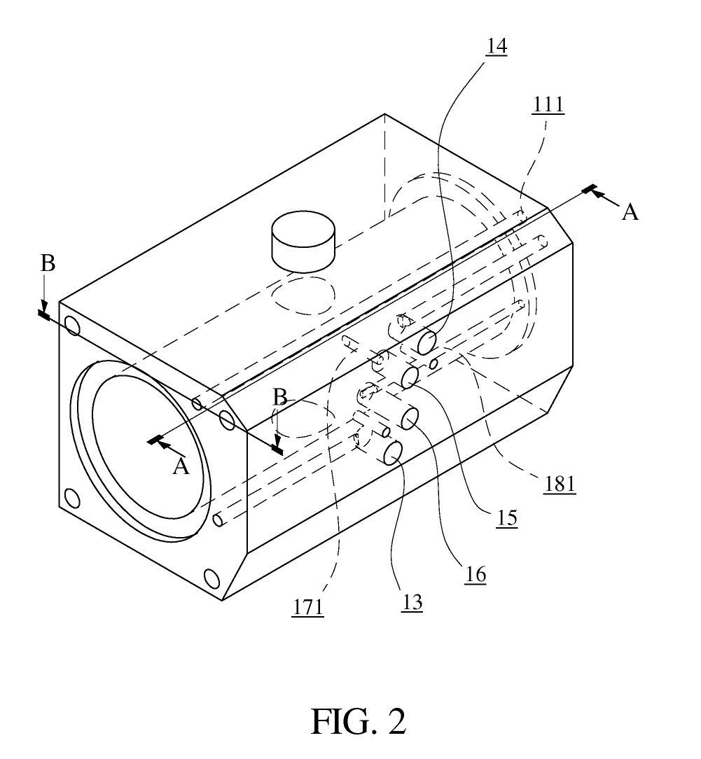

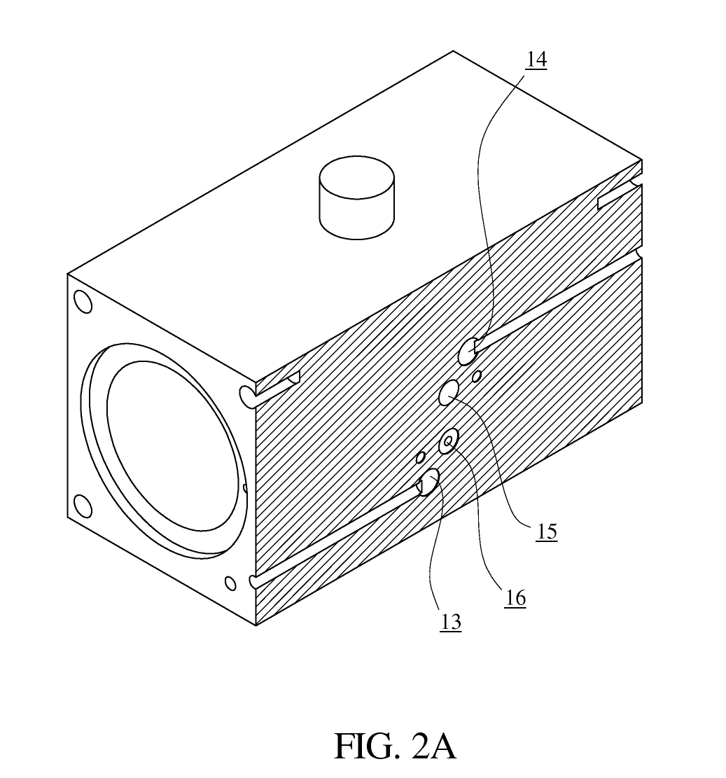

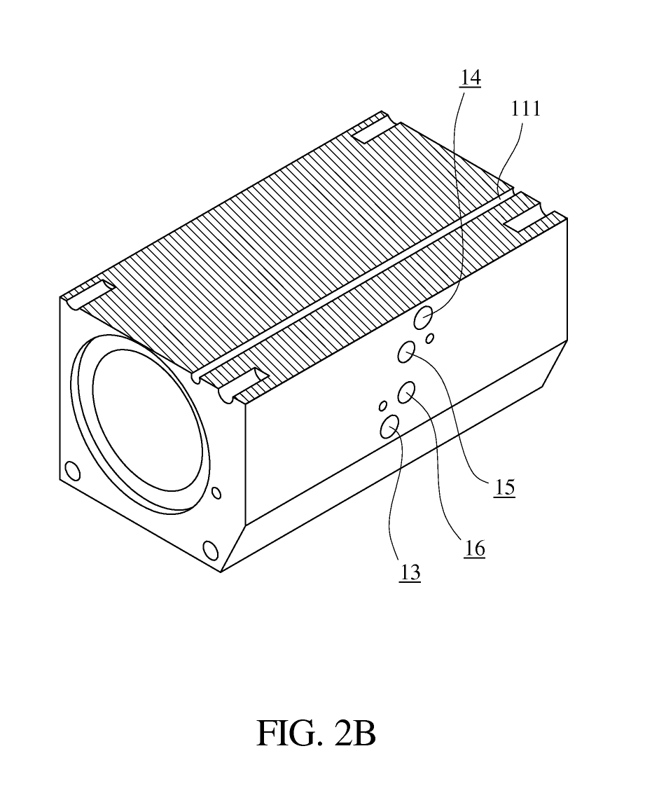

Referring to FIGS. 2 to 5B and 7A, under normal operation in the fail-safe model, the pilot solenoid valve (23) is charged to open the positioning hole 2A (231) and the air partially provided by the air source (3) flows through the single-acting air flow path (213) into the switch system (25) and inside the pilot solenoid valve (23) to compress the spool (2100) inside the flow control valve body (21), and the other portion of the air provided by the air source (3) flows through the first hole (215), the air reservoir air inlet port (211) and the positioning hole 1A (13) of the pneumatic rotary actuator (1) into the air reservoir (11) and fills the air reservoir (11). The air in the air reservoir (11) flows through the positioning hole 1B (14) and the air reservoir outlet port (212) into the intermediate connecting port (210) of the flow control valve body (21), and the air flows from the second hole (216) through the positioning hole 1C (15) into the first inner space (17) to push the piston (12) toward the second inner space (18) and further cause the pinion (19) to rotate in a counterclockwise manner to open the valve body.

Referring to FIGS. 2 to 5B and 7B, under the fail-safe model, when there is power failure or other circumstances which cause the pilot solenoid valve (23) not actuated, the positioning hole 2A (231) is closed and the air partially provided by the air source (3) cannot get into the switch system (25) and the pilot solenoid valve (23) through the single-acting air flow path (213). At this time, the spool (2100) inside the flow control valve body (21) is not compressed and the air provided by the air source (3) flows from the first hole (215), the air reservoir air inlet port (211) and the positioning hole 1A (13) into the air reservoir (11) and fill the air reservoir (11). The air in the air reservoir (11) flows through the positioning hole 1B (14) and the air reservoir outlet port (212) into the intermediate connecting port (210) of the flow control valve body (21), and the air flows from the fourth hole (218) through the positioning hole 1D (16) into the second inner space (18) of the pneumatic rotary actuator (1) to push the piston (12) toward the first inner space (17) and further cause the pinion (19) to rotate in a clockwise manner to close the valve body.

Referring to FIGS. 2 to 5B and 7C, under the fail-safe model, when the pilot solenoid valve (23) is actuated but the air source (3) does not provide air, there is no air flowing into the switch system (25) and the pilot solenoid valve (23), and the spool (2100) is not compressed. At this time, the air in the air reservoir (11) flows through the positioning hole 1B (14) and the air reservoir outlet port (212) into the intermediate connecting port (210) of the flow control valve body (21), and the air flows from the fourth hole (218) through the positioning hole 1D (16) into the second inner space (18) to push the piston (12) toward the first inner space (17) and further cause the pinion (19) to rotate in a clockwise manner to close the valve body. This is so called fail-safe.

Referring to FIGS. 2 to 5B and 8A, under normal operation in the double-acting model, the pilot solenoid valve (23) is charged to open the positioning hole 2A (231) and the air provided by the air source (3) flows through the first hole (215), the air reservoir air inlet port (211) and the positioning hole 1A (13) of the pneumatic rotary actuator (1) into the air reservoir (11) and fills the air reservoir (11). The air in the air reservoir (11) flows through the positioning hole 1B (14) and the air reservoir outlet port (212) through the double-acting air flow path (214) into the switch system (25) and the pilot solenoid valve (23) to further compress the spool (2100) therein. Part of the air in the air reservoir (11) flows through the positioning hole 1B (14) and the air reservoir outlet port (212) to the intermediate connecting port (210) of the flow control valve body (21), and the air flows from the second hole (216) through the positioning hole 1C (15) into the first inner space (17) to push the piston (12) toward the second inner space (18) and further cause the pinion (19) to rotate in a counterclockwise manner to open the valve body.

Referring to FIGS. 2 to 5B and 8B, under the double-acting model, when there is power failure or other circumstances which cause the pilot solenoid valve (23) not actuated, the positioning hole 2A (231) is closed. At this time, the spool (2100) inside the flow control valve body (21) is not compressed and the air provided by the air source (3) flows from the first hole (215), the air reservoir air inlet port (211) and the positioning hole 1A (13) into the air reservoir (11) and fills the air reservoir (11). The air in the air reservoir (11) flows through the positioning hole 1B (14) and the air reservoir outlet port (212) into the intermediate connecting port (210) of the flow control valve body (21), and the air flows from the fourth hole (218) through the positioning hole 1D (16) into the second inner space (18) to push the piston (12) toward the first inner space (17) and further cause the pinion (19) to rotate in a clockwise manner to close the valve body.

Referring to FIGS. 2 to 5B and 8C, under the double-acting model, when the pilot solenoid valve (23) is actuated but the air source (3) does not provide air, the pilot solenoid valve (23) is charged to open the positioning hole 2A (231), and part of the air in the air reservoir (11) flows through the positioning hole 1B (14) and the air reservoir outlet port (212) into the switch system (25) and the pilot solenoid valve (23) through the double-acting air flow path (214) to compress the spool (2100) inside the flow control valve body (21). Also, part of the air in the air reservoir (11) flows from the positioning hole 1B (14) through the air reservoir outlet port (212) into the intermediate connecting port (210) of the flow control valve body (21), and the air flows from the second hole (216) to the positioning hole 1C (15) and through the first inner space (17) to compress the piston (12) to keep its position unchanged.

The pneumatic rotary actuator (1) has an air rechargeable nuzzle (10) to connect the air reservoir (11) and outside, and the air source (3) can provide air directly into the air reservoir (11) through the air rechargeable nuzzle (10), so that under either fail-safe or double-acting model and no matter the pilot solenoid valve (23) is charged or not, the pneumatic rotary actuator (1) can be adjusted under these circumstances.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A pneumatic actuator air flow control system, comprising:
a pneumatic rotary actuator which includes a air reservoir and two pistons which divide an inner portion of the pneumatic rotary actuator into a first inner space between the two pistons and a second inner space which is located at both sides of the two pistons, wherein the air reservoir is not connected with the first inner space and the second inner space, and a couple of actuated racks are formed on the piston toward the first inner space and a pinion is located between the actuated racks and engaged therewith, so the piston drives the actuated racks and the pinion when the piston moves, wherein the pneumatic rotary actuator has positioning holes 1A, 1B, 1C and 1D on its lateral surface, the positioning holes 1A and 1B connected to the air reservoir directly and the positioning hole 1A having a non-return valve; the positioning hole 1C connected with the first inner space through a first tube so the air flows into the first inner space to push the piston toward the second inner space to cause the pinion to rotate in a counterclockwise manner to open the valve body; and the positioning hole 1D connected with the second inner space through a second tube so that the air flows into the second inner space to push the piston toward the first inner space to cause the pinion to rotate in a clockwise manner to close a valve body; and
a solenoid air flow control valve which is quickly switched between a fail-safe mode and a double-acting mode under different circumstances; the solenoid air flow control valve including a flow control valve body, a pilot solenoid valve and a switch system to be formed as one unit, wherein the flow control valve body is connected with the pneumatic rotary actuator and directs air flow from an air source to the air reservoir of the pneumatic rotary actuator, the pilot solenoid valve of the solenoid air flow control valve is adapted to control and change the air flow in and out a piston housing of the pneumatic rotary actuator to further change the rotating direction of the pinion, and the switch system is adapted to manually switch between the fail-safe model and the double-acting model so that the solenoid air flow control valve has three controlling components.

2. The pneumatic actuator air flow control system of claim 1, wherein the flow control valve body has an air reservoir air inlet port and an air reservoir outlet port to connect with the positioning holes 1A and 1B; a single-acting air flow path connected to the air reservoir air inlet port and a double-acting air flow path connected to the air reservoir outlet port, wherein the single-acting air flow path is connected with the switch system through a single-acting connector and the double-acting air flow path is connected with the switch system through a double-acting connector; and the flow control valve body further includes a first hole, a second hole, a third hole, a fourth hole, a fifth hole, an intermediate connecting port and a spool, wherein the first hole is an inlet hole while the third hole and the fifth hole are outlet holes, and the intermediate hole is located at the double-acting air flow path and according to whether the spool is compressed or not to change its position, the air flow from the air reservoir outlet port through the double-acting air flow path is determined to connect to the second hole or the fourth hole, wherein if the intermediate connecting port is connected with the second hole, the air flows through the second hole and the positioning hole 1C of the pneumatic rotary actuator into the first inner space to push the piston toward the second inner space and causes the pinion to rotate in a counterclockwise manner to open the valve body, and if the intermediate connecting port is connected with the fourth hole, the air flows through the fourth hole and the positioning hole 1D of the pneumatic rotary actuator so that the air flows into the second inner space to push the piston toward the first inner space to further drive the pinion to rotate in a clockwise manner to close the valve body; the pilot solenoid valve includes a positioning hole 2A, at least one positioning hole 2B and a plunger to control whether to open or close the positioning hole 2A, wherein the positioning hole 2B is located next to the positioning hole 2A, so that the air flows into the positioning hole 2A is connected with the positioning hole 2B to at least one combining tube, and a ring-shape space directs the air in the combing tube to a compressed tube and the air flows through the switch system from the compressed tube into the flow control valve body to compress the spool; the plunger is adapted to open or close the positioning hole 2A through the pilot solenoid valve and determine whether to connect the positioning hole 2B to the compressed tube according to the situation (open or closed) of the positioning hole 2A; and the switch system is connected with the positioning hole 2A in the pilot solenoid valve through a connecting path, and has a switch spool with axial movement to determine whether the air flows from the double-acting air flow path through the double-acting connector to the switch system (double-acting model) or the air flowing from the single-acting air flow path through the single-acting connector to the switch system (fail-safe model).

3. The pneumatic actuator air flow control system of claim 1, wherein under normal operation in the fail-safe model, the pilot solenoid valve is charged to open the positioning hole 2A and the air partially provided by the air source flows through the single-acting air flow path into the switch system and inside the pilot solenoid valve to compress the spool inside the flow control valve body, and the other portion of the air provided by the air source flows through the first hole, the air reservoir air inlet port and the positioning hole 1A into the air reservoir and fills the air reservoir, wherein the air in the air reservoir flows through the positioning hole 1B and the air reservoir outlet port into the intermediate connecting port of the flow control valve body, and the air flows from the second hole through the positioning hole 1C into the first inner space to push the piston toward the second inner space and further cause the pinion to rotate in a counterclockwise manner to open the valve body.

4. The pneumatic actuator air flow control system of claim 2, wherein under the fail-safe model, when the pilot solenoid valve not actuated, the positioning hole 2A is closed and the air partially provided by the air source is not allowed to get into the switch system and the pilot solenoid valve through the single-acting air flow path, so the spool inside the flow control valve body is not compressed and the air provided by the air source flows from the first hole, the air reservoir air inlet port and the positioning hole 1A into the air reservoir and fills the air reservoir, and the air in the air reservoir flows through the positioning hole 1B and the air reservoir outlet port into the intermediate connecting port of the flow control valve body, and the air further flows from the fourth hole to the positioning hole 1D into the second inner space of the pneumatic rotary actuator to push the piston toward the first inner space and further cause the pinion to rotate in a clockwise manner to close the valve body.

5. The pneumatic actuator air flow control system of claim 2, wherein under the fail-safe model, when the pilot solenoid valve is actuated but the air source does not provide air, no air flows into the switch system and the pilot solenoid valve at this time, so the spool is not compressed and the air in the air reservoir flows through the positioning hole 1B and the air reservoir outlet port into the intermediate connecting port of the flow control valve body, and the air further flows from the fourth hole to the positioning hole 1D into the second inner space to push the piston toward the first inner space and further cause the pinion to rotate in a clockwise manner to close the valve body.

6. The pneumatic actuator air flow control system of claim 2, wherein under normal operation in the double-acting model, the pilot solenoid valve is charged to open the positioning hole 2A and the air provided by the air source flows through the first hole, the air reservoir air inlet port and the positioning hole 1A into the air reservoir and fills the air reservoir, and part of the air in the air reservoir flows from the positioning hole 1B and the air reservoir outlet port through the double-acting air flow path into the switch system and the pilot solenoid valve to further compress the spool therein, while the other part of the air in the air reservoir flows through the positioning hole 1B and the air reservoir outlet port to the intermediate connecting port of the flow control valve body, and the air further flows from the second hole to the positioning hole 1C into the first inner space to push the piston toward the second inner space and further cause the pinion to rotate in a counterclockwise manner to open the valve body.

7. The pneumatic actuator air flow control system of claim 2, wherein under the double-acting model, when the pilot solenoid valve is not actuated, the positioning hole 2A is closed and the spool inside the flow control valve body is not compressed and the air provided by the air source flows from the first hole, the air reservoir air inlet port and the positioning hole 1A into the air reservoir and fills the air reservoir, and the air in the air reservoir flows through the positioning hole 1B and the air reservoir outlet port into the intermediate connecting port of the flow control valve body, and the air further flows from the fourth hole to the positioning hole 1D into the second inner space to push the piston toward the first inner space and further cause the pinion to rotate in a clockwise manner to close the valve body.

8. The pneumatic actuator air flow control system of claim 2, wherein under the double-acting model, when the pilot solenoid valve is actuated but the air source does not provide air, the pilot solenoid valve is charged to open the positioning hole 2A, and part of the air in the air reservoir flows through the positioning hole 1B, the air reservoir outlet port and the double-acting air flow path into the switch system and the pilot solenoid valve to compress the spool inside the flow control valve body, and part of the air in the air reservoir flows through the positioning hole 1B and the air reservoir outlet port into the intermediate connecting port of the flow control valve body, and the air further flows from the second hole to the positioning hole 1C into the first inner space to push the piston toward the second inner space and further cause the pinion to rotate in a counterclockwise manner to open the valve body.

9. The pneumatic actuator air flow control system of claim 2, wherein the pilot solenoid valve further comprising a manual override to manually adjust the plunger and control the positioning hole 2A to open or close.

10. The pneumatic actuator air flow control system of claim 1, wherein the positioning hole 1C is connected with the first inner space through the first tube.

11. The pneumatic actuator air flow control system of claim 1, wherein the positioning hole 1D is connected with the second inner space through the second tube.

12. The pneumatic actuator air flow control system of claim 1, wherein the air reservoir is located at two ends of the pneumatic rotary actuator and connected with the pneumatic rotary actuator with a connecting tube.

13. The pneumatic actuator air flow control system of claim 1, wherein the pneumatic rotary actuator includes an air rechargeable nuzzle to connect the air reservoir and outside, and the air source provides air directly into the air reservoir through the air rechargeable nuzzle.
